(19) United States
(12) Patent Application Publication
(10) Pub. No.: US 2006/0202794 A1
(43) Pub. Date: Sep. 14, 2006

(54) Resettable over-current protection device and method for producing the same

(76) Inventors: Chang-Wei Ho, Taipei County (TW); Yung-Yi Chang, Chung Li City (TW); Shang-Chi Chuang, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/075,652

(22) Filed: Mar. 10, 2005

(51) Int. Cl. H01C 13/00

(52) U.S. Cl. 338/220

(57) ABSTRACT

A resettable over-current protection device has a laminated body with a conductive polymeric sheet laminated by upper and lower electrode sheets, two end terminals wrapping lateral sides of the curved sidewalls of the laminated body, and two insulative sheets covering upper and lower surfaces of the laminated body and filled between the two end terminals. The upper and lower electrode sheets have lateral curved sides symmetrical to each other due to correspondence with the two lateral curved sidewalls so as to define and form a plurality of chip devices.

### BACKGROUND OF THE INVENTION

1. Field of the Invention

The present invention relates to a resettable over-current protection device and a method for producing the same, and particularly relates to a resettable over-current protection device, which contains a polymeric material with a positive temperature coefficient for producing a thermal resistor with a positive temperature coefficient and a method for producing the same.

2. Description of Related Art

The polymeric-based thermal resistor with a positive temperature coefficient, known as PPTC, is composed of conductive grains, generally black carbons, metallic powders, conductive particles, polymeric-based materials and some additives. An increase in temperature or current raises the resistance of the PPTC thermistor, and this additional resistance in the circuit has the effect of reducing the overall current. Once the over current situation is over, the PPTC thermistor cools down; in doing so its internal temperature drops, resulting in the resistance returning to a low state. Therefore, the PPTC thermistor is also called a resettable fuse, which means a polymer device switches the current on or off, and is widely applied to protect against overcurrent or shorts in small electric equipment. In addition, the PPTC thermistor is used to protect, for example, computer peripheral equipment, such as USB ports, telecommunication and network equipment, secondary rechargeable batteries, such as battery packs, power sources, and automobiles, such as mobile starters. FIG. 1 illustrates the operation principle behind the PPTC thermistor. At a normal temperature, the polymeric-based materials are in the crystalline phase and regular structure have conducting chains of the conductive grains. The polymeric-based materials thus have low resistance, such as below 1 ohm, for smoothly conducting electricity by contact between each of the conductive grains such as, for example, black carbons, without changing the crystalline structure where the polymeric molecules form. As the temperature increases due to rising current, the polymeric-based materials maintain this structure but eventually, transition suddenly to an amorphous phase where the molecules are aligned randomly due to the excessive heat. Volume increases and the conductive grains are broken and separated from each other, in order to increase the resistance and return the current back to a low state for overcurrent protection in a very short time. When the temperature drops or the current decreases, the polymeric-based materials return to the crystalline phase, the volume diminishes, and the conductive grains contact to form the conducting chains again. Thus, the resistance of the PPTC thermistor returns to the low state. The concept of the PPTC thermistor obeys the law of the conservation of energy; the heat caused by the increase of the resistance thereof dissipates into the surrounding environment or is added to the temperature thereof. The temperatures of points 1 and 2 as illustrated in FIG. 1 indicate a kind of equilibrium between the surrounding environment and the PPTC thermistor during the normal range of the current or the temperature thereof. When the current or the temperature exceeds a critical value, at point 3 in FIG. 1, a little change of temperature can lead to a dramatic increase in resistance. Once the temperature exceeds point 3, the PPTC thermistor trips so as to increase the resistance thereof rapidly to point 4 in FIG. 1 for restricting the current and protecting the related equipment.

Generally, the PPTC thermistor is manufactured by providing the exclusive ingredient, which includes polymers, conductive grains and additives. The ingredient is mixed and processed as a sheet. Two metallic foils, generally nickel foils, nickel-plated copper foils or copper-nickel alloy foils, sandwich the sheet. Upper and lower electrodes are made via further processes, and a PPTC thermistor is provided. The characteristic of the PPTC thermistor corresponds to the ingredient thereof, and relates to the initial resistance, the trip capability and the reversibility. The ingredient is therefore the top secret in each manufacture. However, the resistance of the PPTC thermistor corresponds to not only the crystalline structure of polymers and the density of the conductive grains, but also the thickness of the sheet and the overlapping area between the two outermost electrodes. In addition, the combination between the electrodes and the polymer sheet, the attachment of the end terminals, the internal stresses after producing, and the practicability and reliability for the client are considerations in the processes.

With respect to FIGS. 2A to 2E, U.S. Pat. No. 6,348,852, the first prior art, discloses two nickel-plated copper foils 1a formed with a plurality of comb-figured grooves 10a in advance, and a PTC polymer sheet 2a laminated by the two foils 1a. The grooves 10a, arranged on a respective on each of the two foils 11a and formed with gaps from the opposite one of end terminals, are opposite and overlap with those on the other one of the foils 1a (in FIG. 2a). The sheet after the sandwich process is further diced with a plurality of openings 11a, which are narrow and long to penetrate through the sheet and alternate with the grooves 10a (in FIG. 2B). A layer of protection coat 4a, epoxy acrylic resin, is provided to cover the grooves 10a by a screen-printing process, but partially exposes the tooth part (in FIG. 2C). The semi-finished product is further electroplated with the nickel layer, which covers the external surfaces of the foils 1a and the inner surfaces of the openings 11a (in FIG. 2D). After the nickel-plating process, the sheet is diced into a plurality of chip devices (in FIG. 2E). The openings 11a of the PPTC thermistor chip illustrated in FIG. 2E are processed via the dicing blade to form a straight line. Corresponding to the relation between the resistance and the overlapped area, the larger the overlapping area is, the less resistance is. An overlapping area of the first prior art, circumscribed by the straight-line geometry of the openings 11a and the grooves 10a, is small due to a wasted area near the end terminals. If the designed overlapping area is small, the corresponding resistance value becomes large, and the margin to trip decreases because the trip current value decided by the ingredient of the sheet is fixed, so as to narrow the application thereof.

Referring to FIGS. 3A to 3G, U.S. Pat. No. 6,023,403, the second prior art, discloses two nickel plates 1b laminated with a layer of PPTC material 2b therein as a sheet (in FIG. 3A) in the first step. The sheet is etched with a plurality of isolation openings 10b as a plurality of strips (in FIG. 3B). Each of the nickel plates 1b is etched with a plurality of separation gaps 11b illustrated in FIG. 3C. The sheet is a layer of photoresist 3b in FIG. 3D, and a predetermined portion of each side of the layer of photoresist 3b is stripped off after developing process in FIG. 3E. After a procedure of copper plating, a copper layer 4b electrically connects the two nickel plates 1b, in order to form upper and lower electrodes isolated by the separation gaps 11b in FIG. 3F. Finally, a tin layer 5b is electroplated on the copper layer 3b (in FIG. 3G), and the finished sheet can be diced into PPTC thermistor chips from the PPTC strips. As in the first prior art, a overlapping area of the second prior art, circumscribed by the straight-line geometry of the upper and lower separation gaps 11b, is small due to a wasted area near the end terminals. If the designed overlapping area is small the corresponding resistance value becomes large, and the margin to trip decreases because the trip current value decided by the ingredient of the sheet is fixed, thus narrowing application thereof.

Referring to FIGS. 4A to 4F, U.S. Pat. No. 5,852,397, the third prior art, discloses two metallic foils 1c laminated with a PPTC layer 2c therein as a laminated sheet (in FIG. 4A). The laminated sheet is penetrated by a plurality of axle holes 10c in an array manner (in FIG. 4B), and further plated with a layer of copper by chemical plating or electroplating or both processes. Inside the axle holes 10c and outside the two metallic foils 1c are covered with the copper layer 4c (in FIG. 4C), in order to connect electrically the two metallic foils 1c to each other. Taking a tin plating process, a tin layer 5c is electroplated on the copper layer 4c in FIG. 4D. A separation slot 11c of each metallic foil 1c with the copper layer 4c and tin layer 5c is etched (in FIG. 4E), and pluralities of PPTC thermistor chips corresponding to a predetermined pattern are diced (in FIG. 4F). The upper and lower separation slots 12c circumscribes the straight-line geometry, which is small due to a wasted area near the end terminals. The end terminal of the third prior art is formed with the copper and tin layers 4c and 5c for electrically connecting the two metallic foils 1c. The cross-sectional surface of the end terminal is too small, due to each passageway 11b to provide good solderability, so that de-wetting and component lifting problems, which seriously affect the practicability and the reliability in clients, occur during the reflow process. Furthermore, the axle hole 11c causes difficulty in the electroplating therein to lower fineness requirements on the end terminal; the reduced fineness makes the joint between the copper layer 4c and the tin 6c crack and peel, or the components crack due to the unbalanced inner stresses after the reflow process. The cross-sectional surface of each axle hole 11c is too small to apply to the PCB normally, because the current on the PCB is easily choked by the small surface of the axle hole 11c. The heat due to the current choke will increase the hazard of tripping before a real over current, and this will absolutely diminish the practicability and the reliability to clients.

Referring to U.S. Pat. No. 6,157,289, the fourth prior art discloses a curved space corresponding to a through hole that utilizes more area near the end terminals, but the end terminal thereof is still formed by plating layers onto each through hole for electrical connection. This structure of the end terminal can solve the problems of the first and second prior arts, but is similar to problems of the third prior art, it is difficult to electroplate inside the through hole, to provide good solderability with the through hole, and heat conduction problems.

### SUMMARY OF THE INVENTION

A resettable over-current protection device and a method for producing the same according to the present invention are provided to improve heat conductivity and heat dissipation capacity, so as to prevent effects of the characteristic and application thereof from the induced heat due to the environment and erroneous design.

A resettable over-current protection device and a method for producing the same according to the present invention are provided to keep the effective area overlapped by the upper and lower electrode sheets. The larger the effective area is, the less the resistance of the device is, so that the margin for tripping is larger and the application of the device is wider.

A resettable over-current protection device and a method for producing the same according to the present invention avoid internal stresses residual in the device from the crack thereof.

A resettable over-current protection device and a method for producing the same according to the present invention increases the plate and solder surface area for good solderability without de-wetting, component lifting and similar problems.

A resettable over-current protection device according to the present invention is described as follows. A laminated body includes a conductive polymeric sheet, and upper and lower electrode sheets sandwiching the conductive polymeric sheet. The laminated body has two lateral curved sidewalls symmetrical to each other, and the conductive polymeric sheet is characterized by a positive temperature coefficient. Two end terminals wrap the lateral sides of the curved sidewalls of the laminated body, electrically connecting the upper and lower electrode sheets in an alternating manner. Two insulative sheets cover upper and lower surfaces of the laminated body and fill between the two end terminals. The upper and lower electrode sheets have lateral curved sides symmetrical to each other due to correspondence with the two lateral curved sidewalls.

A method for producing a resettable over-current protection device according to the present invention is described as follows:

(a) A laminated sheet is prepared, which is formed by pressing a conductive polymeric sheet with upper and lower electrode sheets.

(b) The upper, lower electrode sheets are etched with a plurality of separation grooves, respectively. The separation grooves are curved and discontinuous and the separation grooves alternate at the upper and lower electrode sheets in order to define a plurality of chip devices.

(c) A plurality of lines are pre-cut corresponding to a predetermined pattern on each of the upper and lower electrode sheets. The lines have a plurality of continuous longitudinal curves and a plurality horizontal beelines, and each of the continuous longitudinal curves is symmetric to a neighboring one.

(d) Two insulative sheets are coated on to cover the upper and lower electrode sheets of the laminated sheet, and enclose the separation grooves.

(e) The laminated sheet is segmented into a plurality of chip devices. Each of the chip devices has two lateral curved sidewalls symmetrical to each other.

(f) Each of the chip devices is electroplated when two end terminals are attached to the two lateral curved sidewalls thereof, for electrically connecting the upper and lower electrode sheets in an alternating manner.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter which will form the subject of the claims appended hereto.

### BRIEF DESCRIPTION OF THE DRAWINGS

These and other features, aspects, and advantages of the present invention will become better understood with regard to the following description, appended claims, and accompanying drawings, where:

FIG. 1 is a characteristic plot of PPTC thermistor;

FIGS. 2A to 2E are the perspective views corresponding to the processes for producing a PPTC thermistor of the first prior art;

FIGS. 3A to 3G are the perspective views corresponding to the processes for producing a PPTC thermistor of the second prior art;

FIGS. 4A to 4F are the perspective views corresponding to the processes for producing a PPTC thermistor of the third prior art;

FIG. 5A is a perspective view of a resettable over-current protection device according to a first embodiment of the present invention;

FIG. 5B is a top view of the resettable over-current protection device according to the first embodiment of the present invention;

FIG. 6A is a perspective view of the resettable over-current protection device according to a second embodiment of the present invention;

FIG. 6B is a top view of the resettable over-current protection device according to the second embodiment of the present invention;

FIG. 7 is a flow chart of a method for producing the resettable over-current protection device according to the present invention;

FIGS. 8A to 8I, and FIG. 8X are the perspective views corresponding to a first embodiment according to the first embodiment of the present invention;

FIGS. 9A to 9J are the perspective views corresponding to the method of a second embodiment according to the present invention; and

FIGS. 10A to 10K are the perspective views corresponding to the method of a third embodiment according to the present invention.

### DETAILED DESCRIPTION OF PREFERRED EMBODIMENTS

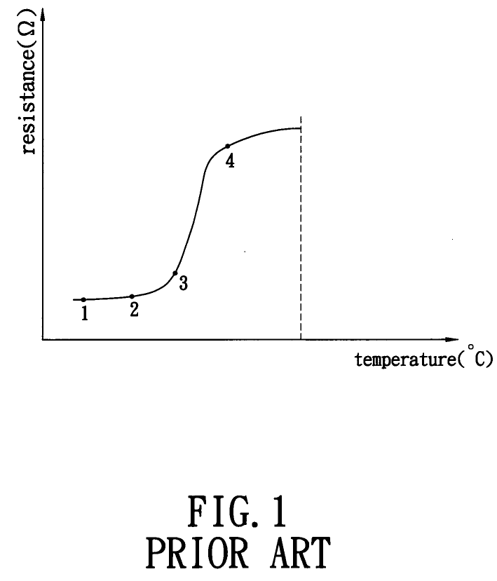

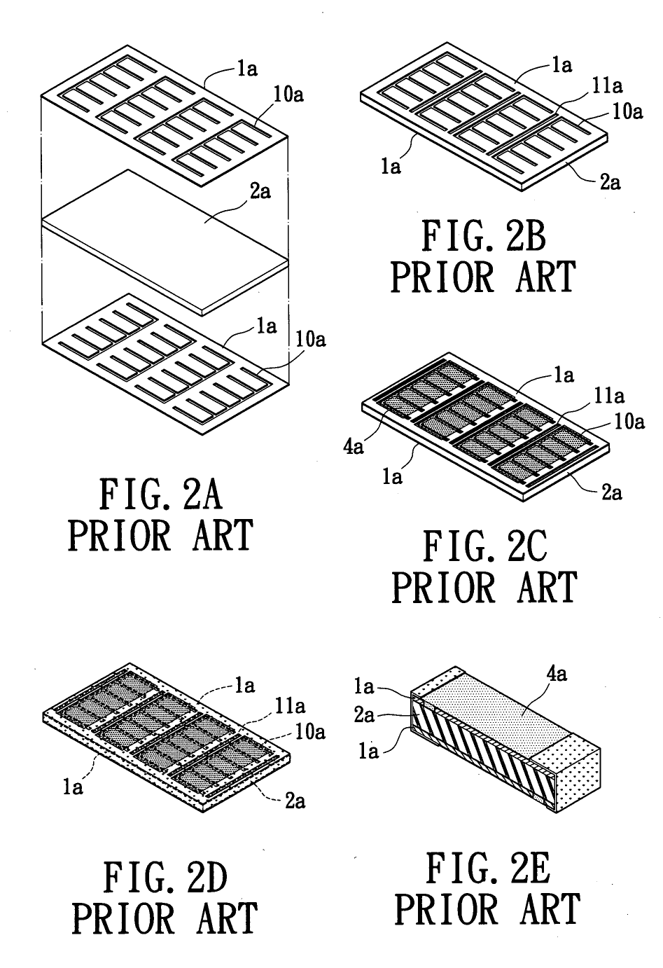

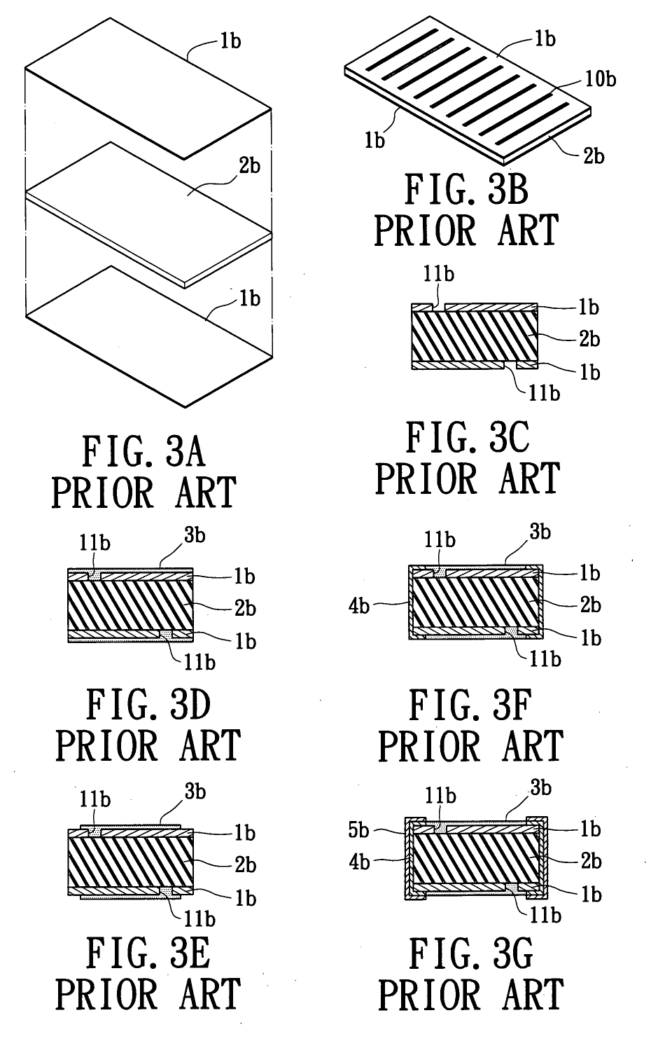

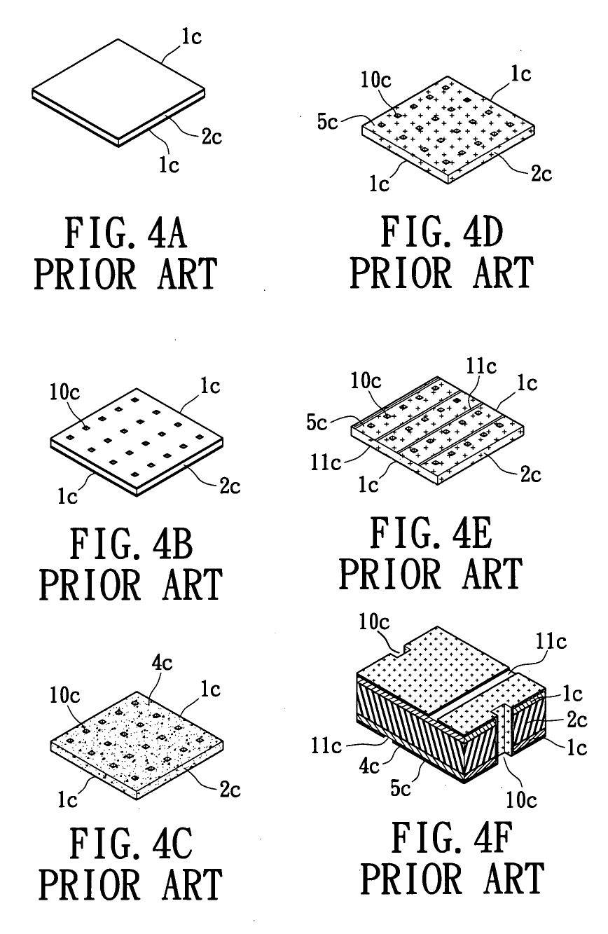

As illustrated in FIG. 1, the PTC polymer materials of the PPTC thermistor are in an amorphous phase from a crystalline phase when a over current or excessive heat occurs. The resistance of the PPTC thermistor increases in several seconds for a trip or open state to restrain the current flow and protect the circuit. After the over current or excessive heat disappears, the resistance returns to the low state. This is known as “resettable”. An incorrectly designed PPTC thermistor, in particular a multilayered thermistor via stack manufacturing, or a high environmental temperature, causes the PPTC thermistor to store up heat and be easily tripped to shut down the operation of the related circuit. Therefore, a resettable over-current protection device and a method for producing the same according to the present invention improve the heat conductivity and the heat dissipation without the effects of the environmental temperature and the wrong design.

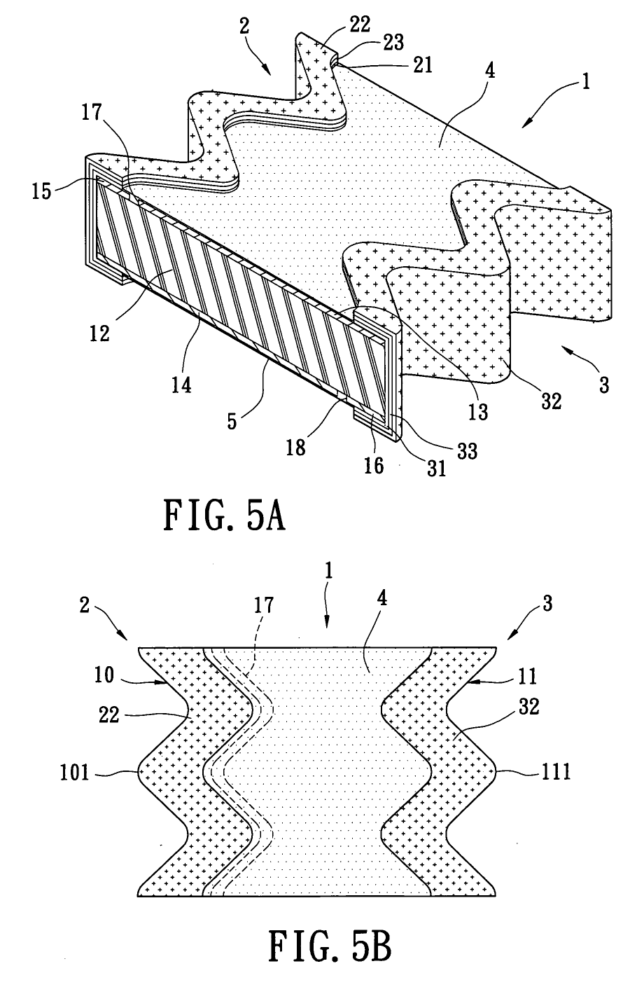

With respect to FIGS. 5A and 5B, a resettable over-current protection device includes a laminated body 1 with two lateral curved sidewalls 10, 11 symmetrical to each other, two end terminals 2, 3 wrapping the lateral sides of the curved sidewalls 10, 11 of the laminated body 1, and two insulative sheets 4, 5 covering the upper and lower surfaces of the laminated body 1 and filling between the two end terminals 2, 3.

The laminated body 1 includes a conductive polymeric sheet 12 with a positive temperature coefficient for determining the resistance, the trip capacity and the resettability, upper and lower electrode sheets 13, 14 disposed under and below the conductive polymeric sheet 12, respectively, and upper and lower conductive sheets 15, 16 disposed under and below the conductive polymeric sheet 12, respectively. The upper electrode sheet 13 is isolated from the upper conductive sheet 15 via an upper separation groove 17 formed therebetween; the lower outer electrode sheet 14 is isolated from the lower conductive sheet 16 via a lower separation groove 18 formed therebetween. In accordance with the present embodiment, the left end terminal 2 electrically connects the electrode sheet 14 and the conductive sheet 15, and the right end terminal 3 electrically connects the conductive sheet 16 and the electrode sheet 13, simultaneously. Thus, the conductive polymeric sheet 12 has two electrodes disposed thereon and isolated from each other. The upper outer electrode sheet 13 is formed from the right curved side 11 and extends inwardly to approach the upper conductive sheet 15; the lower outer electrode sheet 14 is formed from the left curved side 10 and extends inwardly to approach the lower conductive sheet 16. The lateral sides of the two outer electrode sheets 13, 14 correspond to the curved sides 10, 11 of the laminated body 1 and are symmetrical to each other. Therefore, the two outer electrode sheets 13, 14 can form the effective area with the largest overlap under the same chip size, such as 0603,0201 and so on, so as to broaden the application of the resettable over-current protection device. The two insulative sheets 4, 5 enclose the separation grooves 17, 18 and fill between the two end terminals 2, 3. The two outer electrode sheets 13, 14, and the two conductive sheets 15, 16 are made of nickel, copper, nickel-plated copper foil, or copper-nickel alloy materials. Each of the two end terminals 2, 3 includes at least two electroplated layers, of which an outermost layer, a second electroplated layer 22, 32, is made of tin material for soldering. An innermost layer, a first electroplated layer 21, 31, thereof is made of copper or nickel materials. In this embodiment, each of the two end terminals 2, 3 includes three electroplates layers, the first layer 21, 31 is made of copper materials, and a further third electroplated layer 23, 33, which is made of nickel materials, is formed between the first and the second electroplated layers 21, 31 and 22, 32.

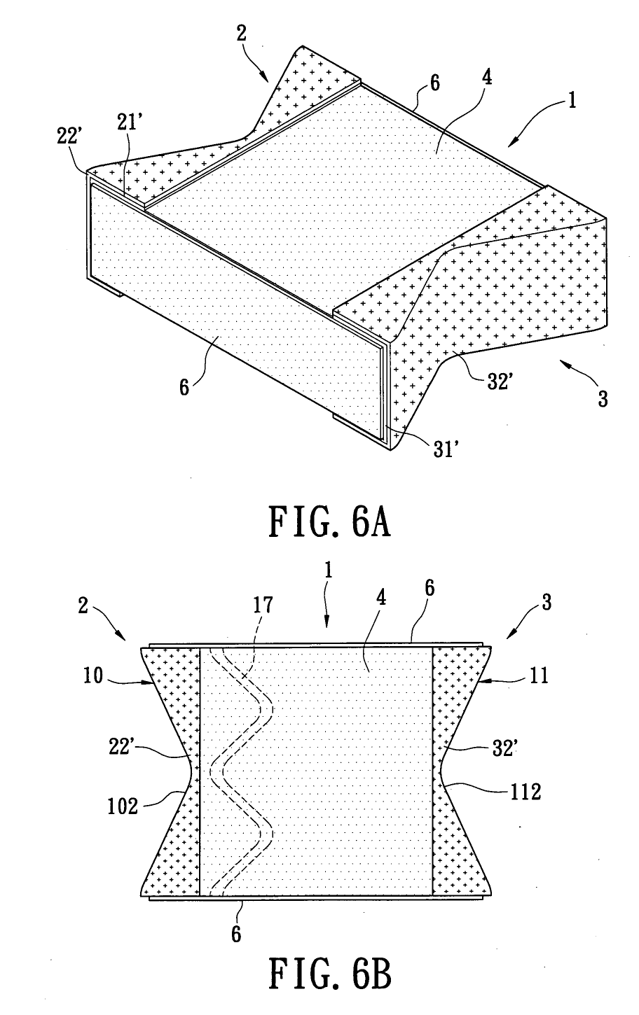

FIG. 6A illustrates at least one concave portion 102, 112 formed on each of the two lateral curved sidewalls 10, 11. In the mentioned embodiment, each of the two lateral curved sidewalls 10, 11 may have a continuous concave-convex portion 101, 111. The variation of each lateral curved sidewall 10, 11 can enlarge the surface area under the same chip size. In an electroplating process, the enlarged surface area is helpful for plating efficiency and fineness; in a soldering process, the enlarged surface area is helpful for solderability without de-wetting and lifting. In addition, the lateral curved sides 10, 11 of the laminated body 1 should be symmetrical because the force to grab the solder should be equal; if residual inner stresses after the soldering process can be avoided, the component will not crack.

Similar to FIGS. 5A and 5B, the two electrode sheets 13, 14, and the two conductive sheets 15, 16 are made of nickel, copper, nickel-plated copper foil, or copper-nickel alloy materials. Each of the two end terminals 2, 3 includes at least two electroplated layers, of which an outermost layer, a second electroplated layer 22, 32, is made of tin material for solder. An innermost layer, a first electroplated layer 21, 31, thereof is made of copper or nickel materials depending on the ingredients of the two outer electrode sheets 13, 14, the two conductive sheets 15, 16. In this embodiment, each of the two end terminals 2, 3 includes three electroplates layers. The first layer 21, 31 is made of copper materials, and a further third electroplated layer 23, 33, which is made of nickel materials, is formed between the first and the second electroplated layers 21′, 31 and 22, 32. FIG. 6B illustrates only two electroplated layers constructed as the lateral end terminals 2, 3; each first electroplated layer 21′, 31′ is plated with nickel materials, and each copper layer 22′, 32′ is disposed on the respective electroplated layer 21, 31′.

The two insulative sheets 4, 5, made of liquid photoimagible solder mask (LPSM) inks and illustrated in FIG. 5A, are configured with curves corresponding to the curved sides 10, 11. In FIG. 6A, another embodiment of the two insulative sheets 4, 5, which can be printed thereon with straight line, is illustrated, because the purpose of the arrangement of the insulative sheets 4, 5 is to fill inside the separation grooves 17, 18 to isolate any two adjacent electrode sheets from each other.

Referring to FIG. 6B, the laminated body 1 further includes two insulative walls 6, which can be also made of liquid photoimagible solder mask (LPSM) inks, coated on a front and a rear thereof, respectively, for isolating any two adjacent electrode sheets from each other. In contrast, FIG. 5B shows the laminated body 1 without any insulative wall 6 because isolation between any two adjacent electrode sheets can be effected by controlling the current density in the electroplating process, and the polymer sheet 12 and the insulative sheets 4, 5 can be excluded for plating.

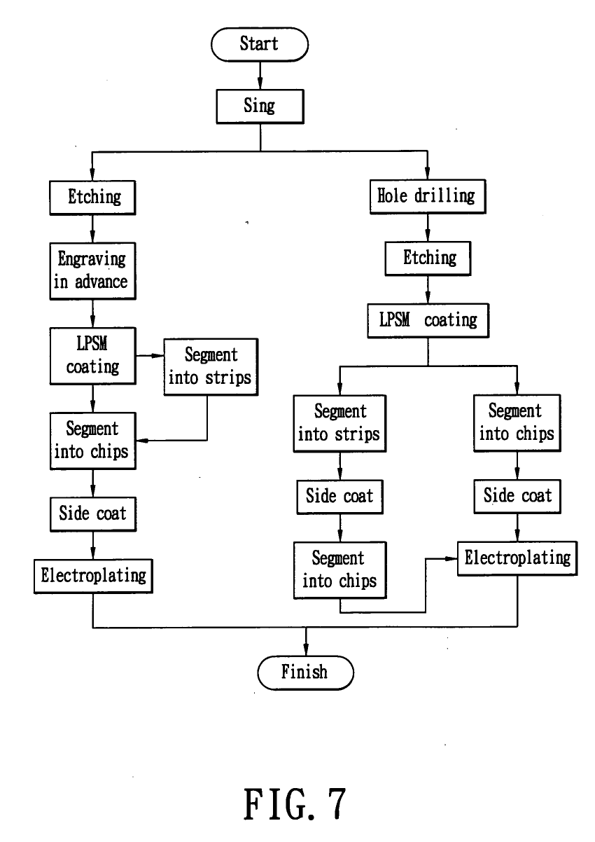

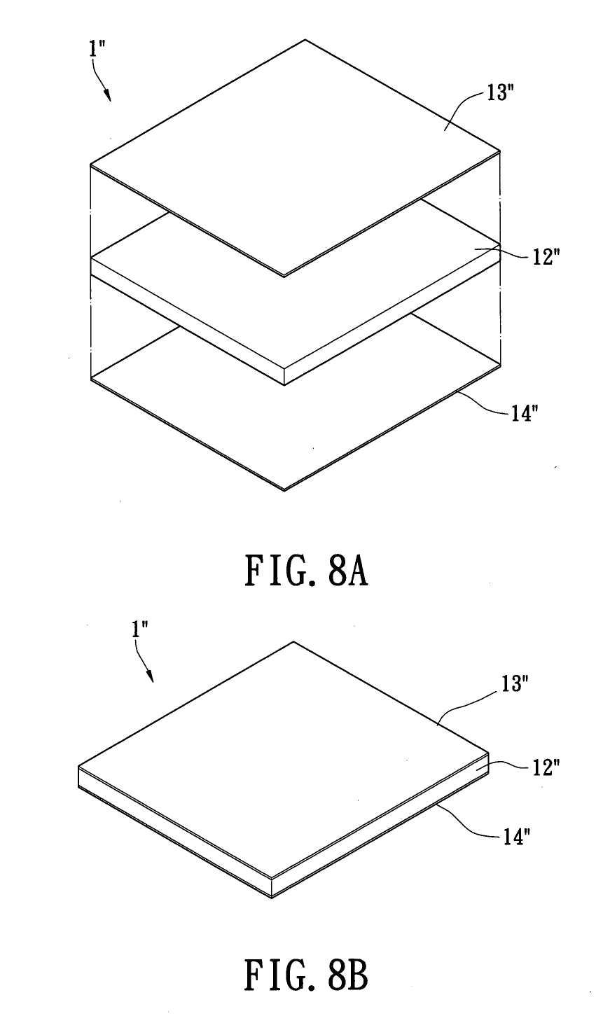

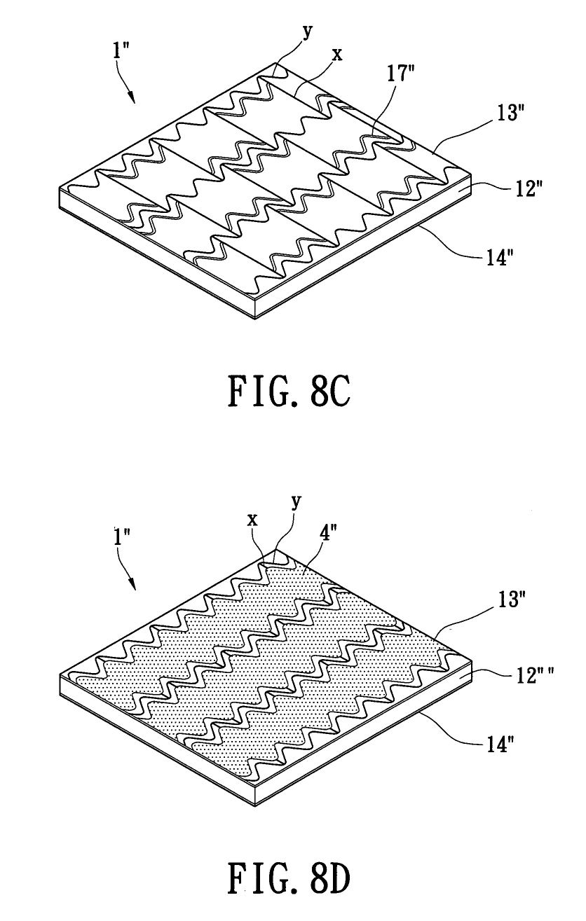

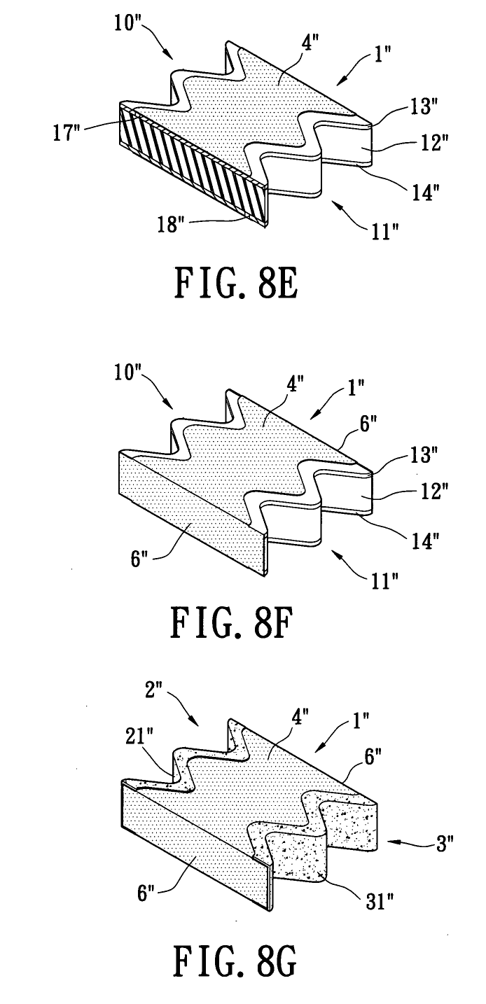

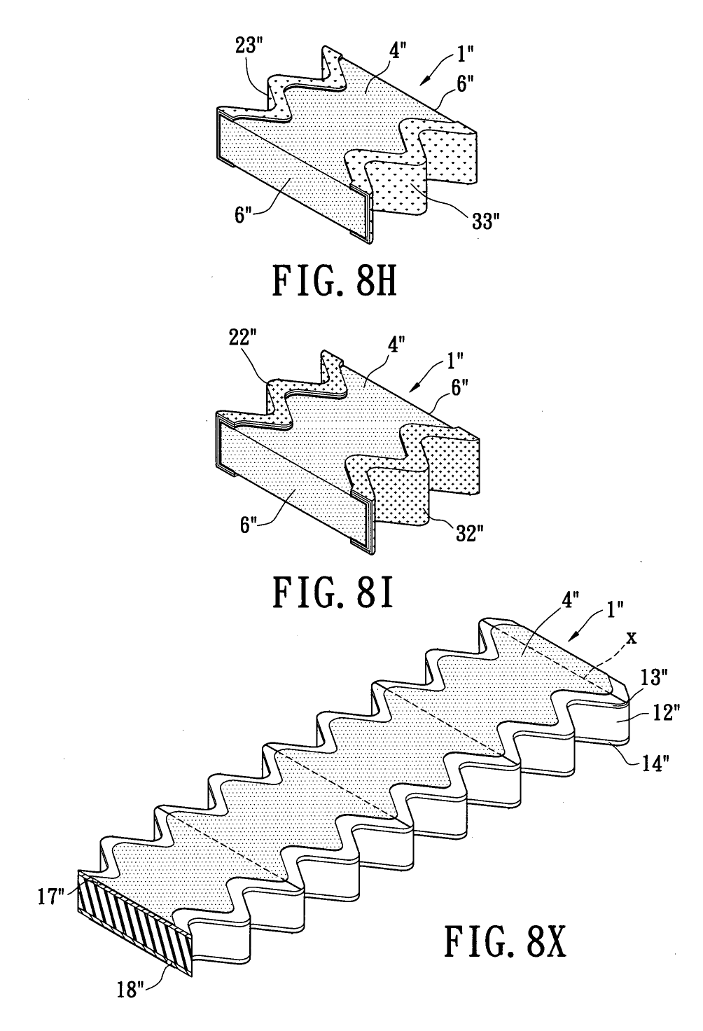

With reference to FIG. 7, at least two methods for producing a resettable over-current protection device are provided. The first method, referring to FIGS. 8A to 8I, and FIG. 8X, includes the following steps.

(a) Single sheet lamination: Referring to FIGS. 8A and 8B, a laminated sheet is prepared by pressing a conductive polymeric sheets 12″ with upper and lower electrode sheets 13″, 14″.

(b) Etching: As is illustrated in FIG. 8C, the upper, lower outer electrode sheets 13″, 14″ are etched with a plurality of separation grooves 17″ respectively, which are discontinuous and curved at least one concave portion or at least one continuous concave-convex portion. The separation grooves 17″ alternate on the upper and lower electrode sheets 13″, 14″ in order to define a plurality of chip devices. The quantity of the concave or the continuous concave-convex portion can be determined by the chip size.

(c) Engraving in advance: As is illustrated in FIG. 8C, a plurality of lines is pre-cut corresponding to a predetermined pattern on each of the upper and lower electrode sheets 13″, 14″. The lines have a plurality of continuous longitudinal curves “y” and a plurality of discontinuous horizontal beelines “x”; each of the continuous longitudinal curves “y” is symmetric to a neighboring one. Step (b) and (c) can be interchanged.

(d) LPSM coating: In accordance with FIG. 8D, two insulative sheets 4″ are coated on, covering the upper and lower electrode sheets 13″, 14″ of the laminated sheet 1″, and enclosing the separation grooves 17″.

(e) Dividing: With respect to FIG. 8E, the laminated sheet 1″ is segmented into a plurality of chip devices. Each of the chip devices has two lateral curved sidewalls 10″, 11″ symmetrical to each other. The dicing further includes punching the laminated sheet 1″ into the chip devices in a direct manner corresponding to the continuous longitudinal curves “y” and the discontinuous horizontal beelines “x”, or, corresponding to FIG. 8X, punching or dicing the laminated sheet 1″ into a plurality of strips corresponding to the continuous longitudinal curves “y”, and further dicing, punching or folding the strips into the chip devices corresponding to the discontinuous horizontal beelines “x”.

(f) Side coat: Two insulative walls 6″ are coated on a front and a rear of each respective chip device, as illustrated in FIG. 8F.

(g) Electroplating: With respect to FIGS. 8G to 8I, each of the chip devices is electroplated as two end terminals 2″ and 3″ attached to the two lateral curved sidewalls 10″ and 11″ thereof, for electrically connecting the inner electrode sheet 20″, upper and lower electrode sheets 13″ and 14″ in an alternating manner. An innermost layer is defined, which innermost layer is electroplated first as a first electroplated layer 21″, 31″ being a copper-plated or nickel-plated layer and defining an outermost layer that is electroplated finally as a tin-plated layer as a second electroplated layer 22″, 32″. The nickel-plated layer is formed between the first electroplated layer 21″, 31″ and the second electroplated layer 22″, 32″ while the first electroplated layer 21″, 31″ is the copper-plated layer. Step (f) can be omitted, because the current density is controlled in the electroplating process and the polymer sheets 12″ and the insulative sheets 4″, 5″ can be excluded for plating.

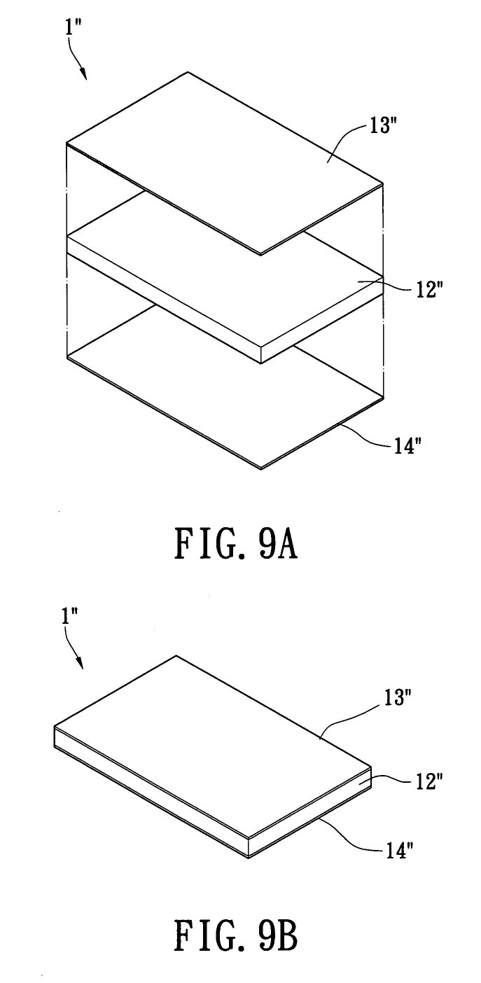

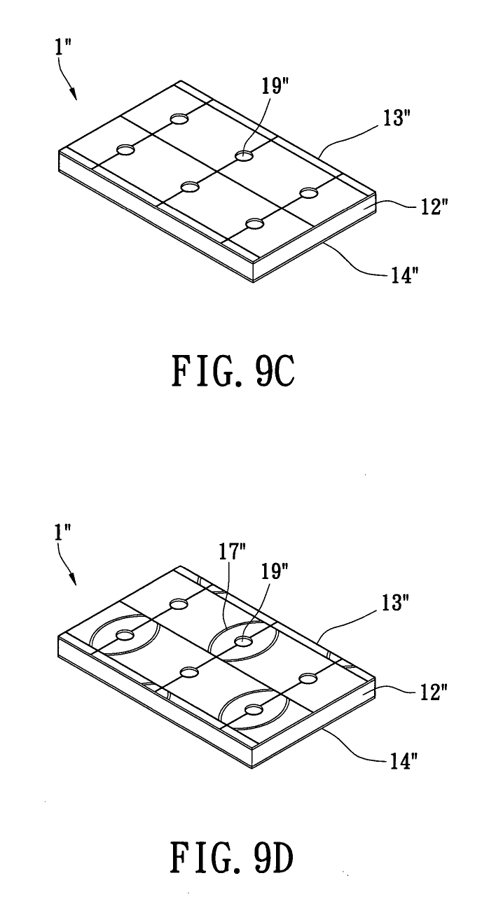

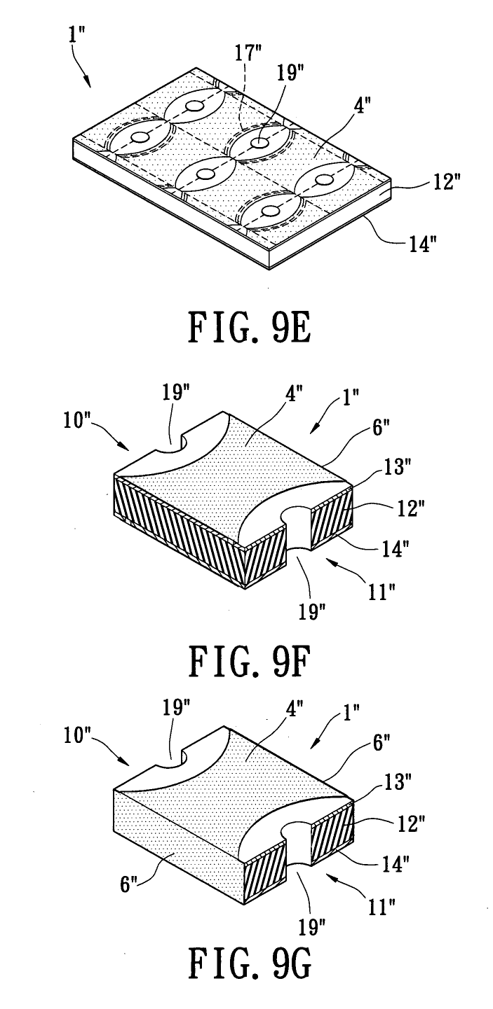

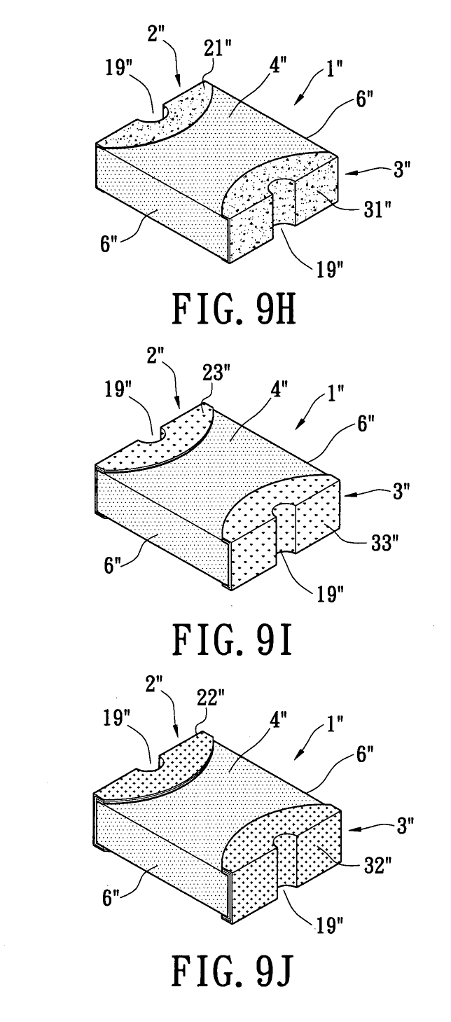

With reference to FIGS. 7 and 9A to 9J, the second method includes the following steps:

(a) Single sheet lamination: Referring to FIGS. 9A and 9B, a respective conductive polymeric sheet 12″ pressed by an upper electrode sheet 13″ and a lower electrode sheet 14″ as a laminated sheet is prepared.

(b) Hole drilling: With respect to FIG. 9C, a plurality of grid lines is pre-cut on the upper and lower electrode sheets 13″, 14″ of the laminated sheet 1″ corresponding to a predetermined pattern. A plurality of drilling holes 19″ penetrate through the laminated sheet 1″ corresponding to the predetermined pattern. Each of the drilled holes 19″ is located on an intersection point of the grid lines.

(c) Etching: Referring to FIG. 9D, the electrode sheets 13″ and 14″ are etched with a plurality of separation grooves 17″, which are discontinuous and curved with a concave portion relative to the drilling holes 19″. The separation grooves 17″ are alternatingly arranged in order to define a plurality of chip devices.

(d) LPSM coating: In accordance with FIG. 9E, two insulative sheets 4″ are coated on, covering the upper and lower electrode sheets 13″, 14″ of the laminated sheet 1″, and enclosing the separation grooves 17″.

(e) Dividing: With respect to FIG. 9F, the laminated sheet 1″ is segmented into a plurality of chip devices. Each of the chip devices has two lateral curved sidewalls 10″, 11″ symmetrical to each other. The dividing step further includes punching the laminated sheet 1″ into the chip devices in a direct manner or punching or dicing the laminated sheet 1″ into a plurality of strips and further dicing, punching or folding the strips into the chip devices, so that each chip device includes two drilling surfaces opposite to each other and corresponding to the drilling holes 19″.

(f) Side coat: Two insulative walls 6″ are coated on a front and a rear of each respective chip device, as illustrated in FIG. 9G.

(g) Electroplating: With respect to FIGS. 9H to 9J, each of the chip devices is electroplated as two end terminals 2″ and 3″ attached to the two lateral curved sidewalls 10″ and 11″ of each chip device.

Subsequent details are same as those described with respect to the first method are not given in further detail here. Step (f) can be omitted, as in the first method.

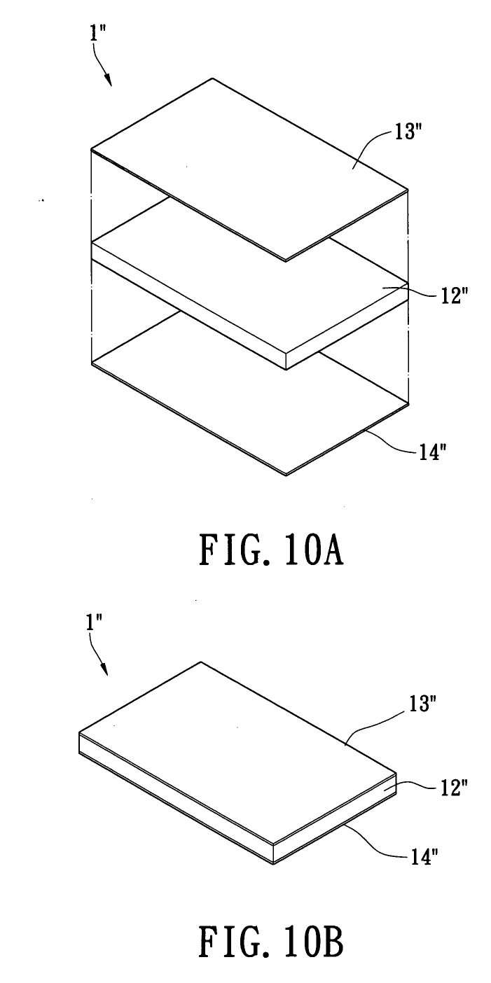

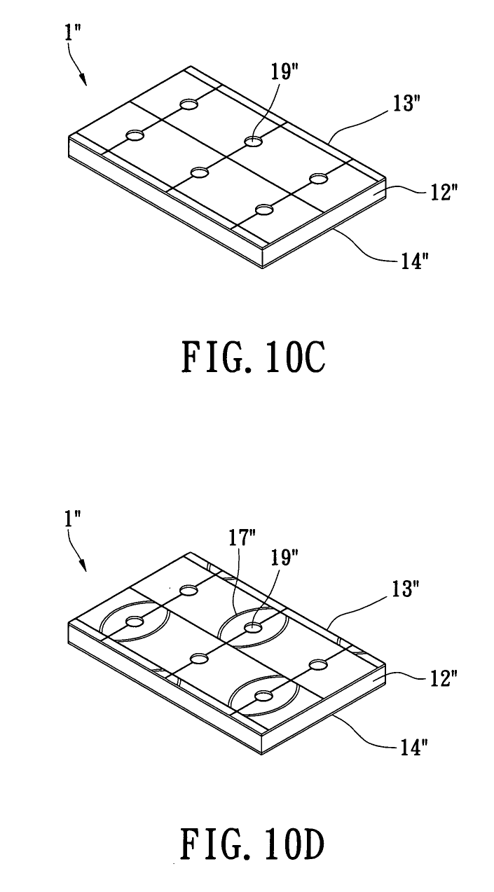

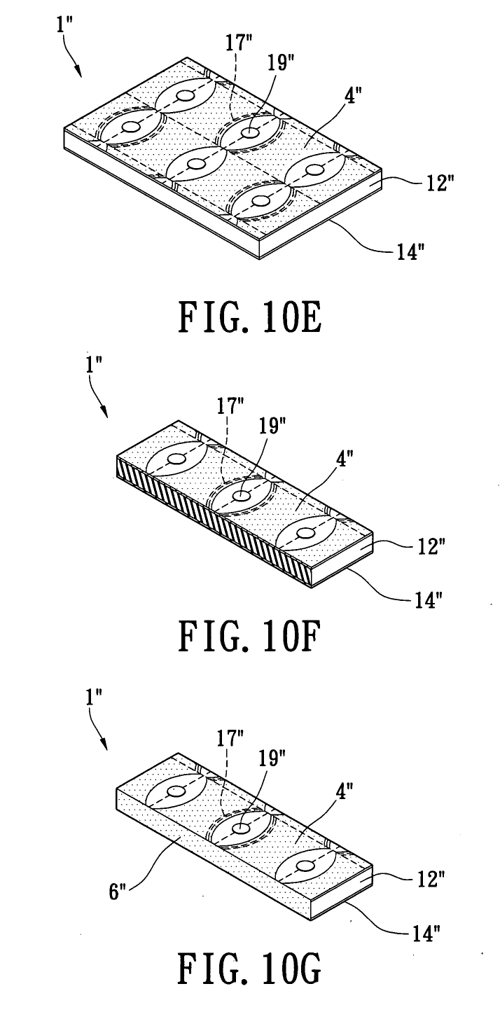

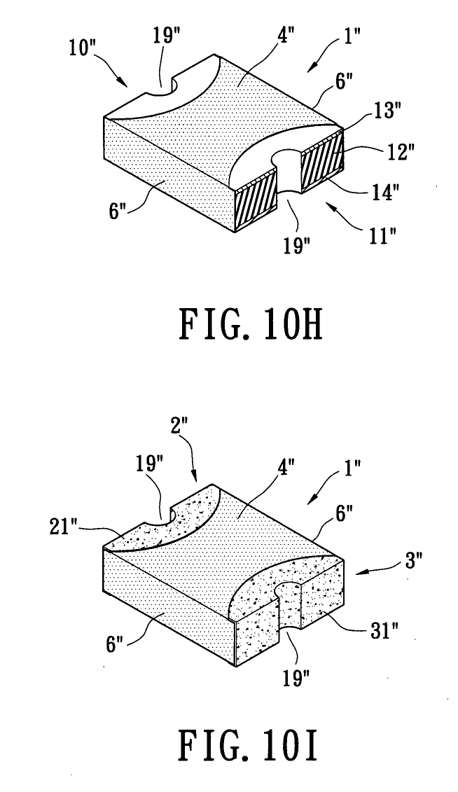

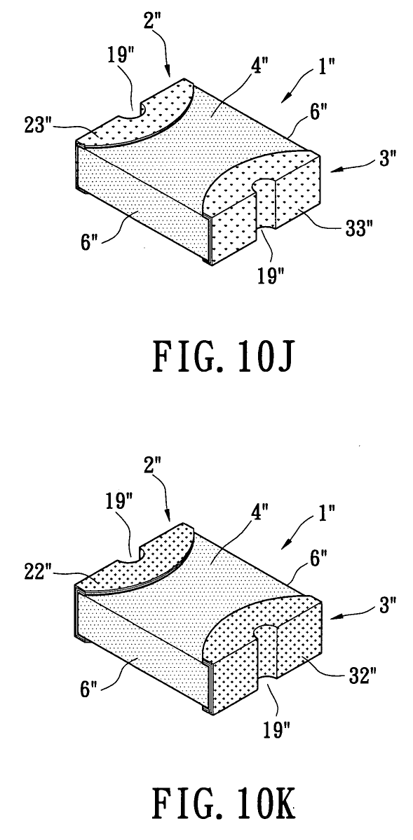

With reference to FIGS. 7, 10A to 10K, the third method includes the following steps.

(a) A conductive polymeric sheet 12″ pressed by the electrode sheets 13″ and 14″ as a laminated sheet is prepared in FIGS. 10A and 10B.

(b) Hole drilling: With respect to FIG. 10C, a plurality of grid lines is pre-cut on the upper and lower electrode sheets 13″, 14″ of the laminated sheet 1″ corresponding to a predetermined pattern. A plurality of drilling holes 19″ penetrate through the laminated sheet 1″ corresponding to the predetermined pattern. Each of the drilled holes 19″ is located on an intersection point of the grid lines.

(c) Etching: Referring to FIG. 10D, the electrode sheets 13″ and 14″ are etched with a plurality of separation grooves 17″, which are discontinuous and curved with a concave portion relative to the drilling holes 19″. The separation grooves 17″ are alternatingly arranged in order to define a plurality of chip devices

(d) LPSM coating: In accordance with FIG. 10E, two insulative sheets 4″ are coated on, covering the upper and lower electrode sheets 13″, 14″ of the laminated sheet 1″, and enclosing the separation grooves 17″.

(e) Dividing into strips: With respect to FIG. 10F, the laminated sheet 1″ is punched or diced into a plurality of strips and followed by further dicing, punching or folding the strips into the chip devices.

(f) Side coat: Two insulative walls 6″ are coated on a front and a rear of each strip, as illustrated in FIG. 10G.

(g) Dividing into devices: Referring to FIG. 10H, the strips can be divided into chip devices, and each chip device includes two drilling surfaces opposite each other and corresponding to the drilling holes 19″.

(h) Electroplating: With respect to FIGS. 10I to 10K, each of the chip devices is electroplated as two end terminals 2″ and 3″ attached to the two lateral curved sidewalls 10″ and 11″ of each chip device. Subsequent steps and embodiments are the same as those described with respect to the first method and no further details are given here. In addition, step (f) can be omitted, because the current density is controlled in the electroplating process and the polymer sheets 12″ and the insulative sheets 4″, 5″ can be excluded for plating, as in the first method.

Therefore, the advantages according to the present invention include:

1. Resolving the problems due to heat clustering by curved surface areas, which can improve the heat conductivity, the fineness of the electroplating process and the solderability during the soldering step.

2. Utilizing symmetrical curved sides thereof to balance the inner stresses to avoid component cracking.

3. The upper and lower electrode sheets of the present device overlap with each other to form a larger effective area, by corresponding to the curved sides, than that of a conventional device with the same chip size.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A resettable over-current protection device comprising:
a laminated body, including a conductive polymeric sheet, and upper and lower electrode sheets sandwiching the conductive polymeric sheet, wherein the laminated body has two lateral curved sidewalls symmetrical to each other, and the conductive polymeric sheet is characterized by a positive temperature coefficient;
two end terminals wrapping lateral sides of the curved sidewalls of the laminated body, and electrically connecting the upper and lower electrode sheets in an alternating manner; and
two insulative sheets covering upper and lower surfaces of the laminated body and filling between the two end terminals;
wherein the upper and lower electrode sheets have lateral curved sides symmetrical to each other due to correspondence with the two lateral curved sidewalls.

2. The device as claimed in claim 1, wherein each of the two lateral curved sidewalls has at least one concave portion.

3. The device as claimed in claim 1, wherein each of the two lateral curved sidewalls has a continuous concave-convex portion.

4. The device as claimed in claim 1, further including a plurality of separation grooves formed between the upper and lower electrode sheets and the two end terminals, respectively, wherein the separation grooves are arranged in an alternating manner, and the two insulative sheets cover the separation grooves, respectively.

5. The device as claimed in claim 1, wherein the two outer electrode sheets are made of nickel, copper, nickel-plated copper foil, or copper-nickel alloy materials.

6. The device as claimed in claim 1, wherein each of the two end terminals includes at least two electroplated layers, wherein an outermost layer thereof is made of tin material.

7. The device as claimed in claim 6, wherein the electroplated layers have an innermost layer made of copper or nickel material.

8. The device as claimed in claim 1, wherein the two insulative sheets are made of liquid photoimagible solder mask (LPSM) inks.

9. The device as claimed in claim 1, wherein each of the two insulative sheets is coated along the two lateral curved sidewalls of the laminated body, so as to have lateral curved sides symmetrical to each other due to the correspondence with the two lateral curved sidewalls.

10. The device as claimed in claim 1, further including two insulative walls coated on a front and a rear of the laminated body, respectively.

11. The device as claimed in claim 10, wherein the two insulative walls are made of liquid photoimagible solder mask (LPSM) inks.

12. A method for producing a resettable over-current protection device, comprising:
preparing a laminated sheet formed by pressing a conductive polymeric sheet with upper and lower electrode sheets;
etching the upper, lower electrode sheets with a plurality of separation grooves, respectively, wherein the separation grooves are curved and discontinuous and the separation grooves alternate on the upper and lower electrode sheets in order to define a plurality of chip devices;
pre-cutting a plurality of lines corresponding to a predetermined pattern on each of the upper and lower electrode sheets, wherein the lines have a plurality of continuous longitudinal curves and a plurality of discontinuous horizontal beelines, and each of the continuous longitudinal curves is symmetric to a neighboring curve;
coating on two insulative sheets covering the upper and lower electrode sheets of the laminated sheet, and enclosing the separation grooves;
segmenting the laminated sheet into a plurality of chip devices, wherein each of the chip devices has two lateral curved sidewalls symmetrical to each other; and
electroplating each of the chip devices as two end terminals attached to the two lateral curved sidewalls thereof, for electrically connecting the upper and lower electrode sheets in an alternating manner.

13. The method as claimed in claim 12, wherein each of the two lateral curved sidewalls has at least one concave portion.

14. The method as claimed in claim 12, wherein each of the two lateral curved sidewalls has at least one continuous concave-convex portion

15. The method as claimed in claim 12, wherein the step of segmenting the laminated sheet into the chip devices further includes:
punching the laminated sheet into the chip devices in a direct manner corresponding to the continuous longitudinal curves and the discontinuous horizontal beelines.

16. The method as claimed in claim 12, wherein the step of segmenting the laminated sheet into the chip devices further includes:
punching or dicing the laminated sheet into a plurality of strips corresponding to the continuous longitudinal curves; and
dicing, punching or folding the strips into the chip devices corresponding to the discontinuous horizontal beelines.

17. The method as claimed in claim 12, further including a step before the step of electroplating the chip devices, wherein:
two insulative walls are coated on a front and a rear of each respective chip device.

18. The method as claimed in claim 12, wherein the step of electroplating chip devices includes:
electroplating at least two layers on the two lateral curved sidewalls, and defining an innermost layer electroplated first as a first electroplated layer, wherein the innermost layer is a copper-plated or nickel-plated layer.

19. The method as claimed in claim 18, wherein the step of electroplating chip devices includes:
defining an outermost layer, wherein the outermost layer is electroplated as a tin-plated layer.

20. The method as claimed in claim 19, wherein the step of electroplating chip devices includes:
providing a nickel-plated layer formed between the copper-plated layer and the tin-plated layer when the first electroplated layer is the copper-plated layer.

21. A method for producing a resettable over-current protection device, comprising:
preparing a laminated sheet, formed by pressing a conductive polymeric sheet with upper and lower electrode sheets;
arranging a plurality of drilling holes penetrating through the laminated sheet corresponding to a predetermined pattern, and pre-cutting a plurality of grid lines on the upper and lower electrode sheets of the laminated sheet corresponding to the predetermined pattern, wherein each of the drilled holes is located on an intersection point of the grid lines;
etching the upper, lower outer electrode sheets with a plurality of separation grooves, respectively, wherein the separation grooves are curved and discontinuous and the separation grooves alternate on the upper and lower outer electrode sheets and the inner electrode sheets, in order to define a plurality of chip devices;
coating on two insulative sheets covering the upper and lower electrode sheets of the laminated sheet, and enclosing respective separation grooves;
segmenting the laminated sheet into a plurality of chip devices, wherein each of the chip devices has two lateral drilled surfaces symmetrical to each other; and
electroplating each of the chip devices as two end terminals attached to the two lateral curved sidewalls thereof, for electrically connecting the inner electrode sheet, upper and lower electrode sheets in an alternating manner.

22. The method as claimed in claim 21, wherein the step of segmenting the laminated sheet into the chip devices further includes:
punching the laminated sheet into the chip devices in a direct manner corresponding to the continuous longitudinal curves and the discontinuous horizontal beelines.

23. The method as claimed in claim 22, further including a step before the step of electroplating the chip devices, wherein:
two insulative walls are coated on a front and a rear of each respective chip device.

24. The method as claimed in claim 21, wherein the step of segmenting the laminated sheet into the chip devices further includes:
punching or dicing the laminated sheet into a plurality of strips corresponding to the continuous longitudinal curves; and
dicing, punching or folding the strips into the chip devices corresponding to the discontinuous horizontal beelines.

25. The method as claimed in claim 24, further including a step before the step of making the chip devices, includes coating two insulative walls on a front and a rear of each respective strip.

26. The method as claimed in claim 24, further including a step before the step of electroplating the chip devices, includes coating two insulative walls on a front and a rear of each respective chip device.

27. The method as claimed in claim 21, wherein the step of electroplating chip devices includes:
electroplating at least two layers on the two lateral curved sidewalls, and defining an innermost layer, wherein the innermost layer is electroplated first as a first electroplated layer and is a copper-plated or nickel-plated layer.

28. The method as claimed in claim 27, wherein the step of electroplating chip devices includes:
defining an outermost layer, wherein the outermost layer is electroplated as a tin-plated layer.

29. The method as claimed in claim 28, wherein the step of electroplating chip devices includes:
providing a nickel-plated layer formed between the copper-plated layer and the tin-plated layer when the first electroplated layer is the copper-plated layer.
